(19) United States
(12) Patent Application Publication
(10) Pub. No.: US 2020/0002172 A1
(43) Pub. Date: Jan. 2, 2020

(54) PRODUCTION METHOD FOR FIBROUS CARBON NANOSTRUCTURE DISPERSION LIQUID, AND FIBROUS CARBON NANOSTRUCTURE DISPERSION LIQUID

(71) Applicant: ZEON CORPORATION, Chiyoda-ku, Tokyo (JP)

(72) Inventor: Masahiro SHIGETA, Chiyoda-ku, Tokyo (JP)

(73) Assignee: ZEON CORPORATION, Chiyoda-ku Tokyo (JP)

(21) Appl. No.: 16/490,681

(22) PCT Filed: Mar. 8, 2018
(86) PCT No.: PCT/JP2018/009074

§ 371 Date: Sep. 3, 2019

(30) Foreign Application Priority Data
Mar. 31, 2017 (JP) 2017-072340

(51) Int. Cl. C01B 32/174; B01D 21/26; B01D 63/02; B01D 63/16

(52) U.S. Cl. CPC C01B 32/174; B01D 21/262; B01D 63/02; B01D 63/16; C01P 2006/60; C01B 2202/32; C01B 2202/02; C01B 2202/06; C01P 2004/133; C01B 2202/36

(57) ABSTRACT

Provided are a method of efficiently producing a fibrous carbon nanostructure dispersion liquid having high dispersibility, and a fibrous carbon nanostructure dispersion liquid having high dispersibility. A production method for a fibrous carbon nanostructure dispersion liquid comprises a step of performing continuous centrifugal separation on a solution containing fibrous carbon nanostructures and a solvent.

### TECHNICAL FIELD

The present disclosure relates to a production method for a fibrous carbon nanostructure dispersion liquid, and a fibrous carbon nanostructure dispersion liquid.

### BACKGROUND

In recent years, fibrous carbon nanostructures such as carbon nanotubes (hereafter also referred to as “CNTs”) have been attracting attention as materials excellent in electrical conductivity, thermal conductivity, and mechanical characteristics (for example, see PTL 1).

A dispersion liquid obtained by dispersing CNTs in a solvent (CNT dispersion liquid) is a basic intermediate material of a CNT paint or a CNT coating liquid.

Examples of CNT dispersion liquid production methods include wet high-pressure jet mill, bead mill, and ultrasound. All of these methods have a problem in that undispersed CNTs or CNTs with low dispersibility remain in a produced CNT dispersion liquid.

### CITATION LIST

### Patent Literature

PTL 1: JP 4621896 B2

### SUMMARY

### Technical Problem

Centrifugal separation is effective in removing undispersed CNTs or CNTs with low dispersibility in a produced CNT dispersion liquid. Batch-type centrifugal separation, however, requires much time and labor for the centrifugal separation step, and is industrially impractical. Moreover, increasing the CNT concentration in a process of CNT dispersion is likely to result in poor CNT dispersion.

It could therefore be helpful to provide a method of efficiently producing a fibrous carbon nanostructure dispersion liquid having high dispersibility, and a fibrous carbon nanostructure dispersion liquid having high dispersibility.

### Solution to Problem

A production method for a fibrous carbon nanostructure dispersion liquid according to the present disclosure is a production method for a fibrous carbon nanostructure dispersion liquid comprising a step of performing continuous centrifugal separation on a solution containing fibrous carbon nanostructures and a solvent. Thus, a fibrous carbon nanostructure dispersion liquid having high dispersibility can be produced efficiently.

Preferably, the production method for a fibrous carbon nanostructure dispersion liquid according to the present disclosure comprises a step of concentrating the solution using a hollow fiber membrane filter, before the step of performing continuous centrifugal separation.

Preferably, the production method for a fibrous carbon nanostructure dispersion liquid according to the present disclosure comprises a step of concentrating the solution using a ceramic rotary filter, before the step of performing continuous centrifugal separation.

Preferably, in the production method for a fibrous carbon nanostructure dispersion liquid according to the present disclosure, the solution contains at least CNTs that satisfy 0.20<3σ/Av<0.60, where Av is an average diameter of the fibrous carbon nanostructures, and 3σ is a diameter distribution of the fibrous carbon nanostructures.

Preferably, in the production method for a fibrous carbon nanostructure dispersion liquid according to the present disclosure, a BET specific surface area of the fibrous carbon nanostructures contained in the solution is 600 m²/g or more.

Preferably, in the production method for a fibrous carbon nanostructure dispersion liquid according to the present disclosure, an oxygen content of the fibrous carbon nanostructures contained in the solution is 1 at % or more.

Preferably, in the production method for a fibrous carbon nanostructure dispersion liquid according to the present disclosure, an average diameter of the fibrous carbon nanostructures contained in the solution is 10 nm to 1000 nm.

Preferably, in the production method for a fibrous carbon nanostructure dispersion liquid according to the present disclosure, an absorbance of the solution at a wavelength of 1000 nm is 1.5 to 8.0.

A fibrous carbon nanostructure dispersion liquid according to the present disclosure is a fibrous carbon nanostructure dispersion liquid obtainable by the above-described method. Thus, a fibrous carbon nanostructure dispersion liquid having high dispersibility can be obtained.

### Advantageous Effect

It is therefore possible to provide a method of efficiently producing a fibrous carbon nanostructure dispersion liquid having high dispersibility, and a fibrous carbon nanostructure dispersion liquid having high dispersibility.

### DETAILED DESCRIPTION

One of the disclosed embodiments will be described below. The following description is intended for illustrative purposes only, and is not intended to limit the scope of the present disclosure in any way.

Herein, each numerical range includes the lower limit and the upper limit of the range, unless otherwise noted. For example, a range of 10 nm to 1000 nm includes the lower limit 10 nm and the upper limit 1000 nm, i.e. denotes 10 nm or more and 1000 nm or less.

In the present disclosure, the “average diameter (Av) of the fibrous carbon nanostructures” and the “diameter standard deviation (σ: sample standard deviation) of the fibrous carbon nanostructures” are measured by the methods described in the EXAMPLES section.

In the present disclosure, the “BET specific surface area” refers to a nitrogen adsorption specific surface area measured by the BET method.

In the present disclosure, the “oxygen content of the fibrous carbon nanostructures” is measured by the method described in the EXAMPLES section.

In the present disclosure, the “average diameter of the fibrous carbon nanostructures” refers to a cumulant average diameter, and is measured by the method described in the EXAMPLES section.

In the present disclosure, the “absorbance of the fibrous carbon nanostructure dispersion liquid” is measured by the method described in the EXAMPLES section.

### Production Method for Fibrous Carbon Nanostructure Dispersion Liquid

A production method for a CNT dispersion liquid according to the present disclosure is a production method for a fibrous carbon nanostructure dispersion liquid comprising a step (hereafter also simply referred to as “continuous centrifugal separation step”) of performing continuous centrifugal separation on a solution containing fibrous carbon nanostructures and a solvent (hereafter, the simple term “solution” refers to a solution containing fibrous carbon nanostructures and a solvent before continuous centrifugal separation, unless otherwise noted). Thus, a fibrous carbon nanostructure dispersion liquid having high dispersibility can be produced efficiently.

<Fibrous Carbon Nanostructures>

The fibrous carbon nanostructures for producing the fibrous carbon nanostructure dispersion liquid are not limited, and may be publicly known fibrous carbon nanostructures. Examples of the fibrous carbon nanostructures include CNTs and vapor-grown carbon fibers. One of these fibrous carbon nanostructures may be used individually, or two or more of these fibrous carbon nanostructures may be used in combination.

The CNTs are, for example, single-walled CNTs or multi-walled CNTs. The CNTs are preferably CNTs having from one to five walls, and more preferably single-walled CNTs. Other examples include carbon nanotubes (SGCNTs) produced by the super growth method described in WO 2006/011655 A1, JP 2016-190772 A, etc. Preferably, the fibrous carbon nanostructures include CNTs or are CNTs.

In the production method for a fibrous carbon nanostructure dispersion liquid according to the present disclosure, the solution preferably contains at least fibrous carbon nanostructures that satisfy 0.20 <3σ/Av<0.60, where Av is the average diameter of the fibrous carbon nanostructures, and 3σ is the diameter distribution of the fibrous carbon nanostructures.

In the production method for a fibrous carbon nanostructure dispersion liquid according to the present disclosure, the BET specific surface area of the fibrous carbon nanostructures contained in the solution is preferably 600 m²/g or more, and more preferably 900 m²/g to 1500 m²/g.

In the production method for a fibrous carbon nanostructure dispersion liquid according to the present disclosure, the oxygen content of the fibrous carbon nanostructures contained in the solution is preferably 1 at % or more. The method of limiting the oxygen content of the fibrous carbon nanostructures to this range is not limited. For example, a method of heating the fibrous carbon nanostructures in a nitric acid solution of 40% concentration may be used. The oxygen content is preferably 2 at % to 8 at %.

In the production method for a fibrous carbon nanostructure dispersion liquid according to the present disclosure, the average diameter of the fibrous carbon nanostructures contained in the solution is preferably 10 nm to 1000 nm.

In the production method for a fibrous carbon nanostructure dispersion liquid according to the present disclosure, the absorbance of the solution at a wavelength of 1000 nm is preferably 1.5 to 8.0. The absorbance is more preferably 2.0 to 6.5.

<Solvent>

The solvent may be, for example, a non-halogen solvent or a non-aqueous solvent. Examples of the solvent include water; alcohols such as methanol, ethanol, n-propanol, isopropanol, n-butanol, isobutanol, t-butanol, pentanol, hexanol, heptanol, octanol, nonanol, decanol, amyl alcohol, methoxy propanol, propylene glycol, and ethylene glycol; ketones such as acetone, methyl ethyl ketone, and cyclohexanone; esters such as ethyl acetate, butyl acetate, ethyl lactate, esters of α-hydroxy carboxylic acids, and benzyl benzoate; ethers such as diethyl ether, dioxane, tetrahydrofuran, and monomethyl ether; amide-based polar organic solvents such as N,N-dimethylformamide and N-methylpyrrolidone; aromatic hydrocarbons such as toluene, xylene, chlorobenzene, ortho-dichlorobenzene, and para-dichlorobenzene; and salicylaldehyde, dimethylsulfoxide, 4-methyl-2-pentanone, N-methylpyrrolidone, γ-butyrolactone, and tetramethyl ammonium hydroxide. Of these, water, isopropanol, and methyl ethyl ketone are preferable, in terms of particularly excellent dispersibility. One of these solvents may be used individually, or two or more of these solvents may be used in combination. The pH of water may be adjusted using hydrochloric acid, nitric acid, sulfuric acid, acetic acid, sodium hydroxide, ammonia, sodium hydrogen carbonate, calcium hydroxide, or the like.

<Dispersant>

The solution may or may not contain a publicly known dispersant. The dispersant may be selected as appropriate based on the dispersibility of the fibrous carbon nanostructures, the solubility of the fibrous carbon nanostructures in the solvent, and the like. Examples of the dispersant include a surfactant, a synthetic polymer, and a natural polymer. One of these dispersants may be used individually, or two or more of these dispersants may be used in combination.

Examples of the surfactant include monoalkyl sulfate (sodium dodecylsulfonate, etc.), sodium deoxycholate, sodium cholate, alkyl benzene sulfonate (sodium dodecylbenzenesulfonate, etc.), polyoxyethylene alkyl ether, polyoxyethylene alkyl phenyl ether, alkyl dimethylamine oxide, alkylcarboxybetaine, alkyltrimethylammonium salt, and alkylbenzyl dimethylammonium salt.

Examples of the synthetic polymer include polyether diol, polyester diol, polycarbonate diol, polyvinyl alcohol, partially saponified polyvinyl alcohol, acetoacetyl group-modified polyvinyl alcohol, acetal group-modified polyvinyl alcohol, butyral group-modified polyvinyl alcohol, silanol group-modified polyvinyl alcohol, ethylene-vinyl alcohol copolymer, ethylene-vinyl alcohol-vinyl acetate copolymer resin, dimethylaminoethyl acrylate, dimethylaminoethyl methacrylate, acrylic resin, epoxy resin, modified epoxy resin, phenoxy resin, modified phenoxy-based resin, phenoxy ether resin, phenoxy ester resin, fluorine-based resin, melamine resin, alkyd resin, phenolic resin, polyacrylamide, polyacrylic acid, polystyrene sulfonic acid, polyethylene glycol, and polyvinylpyrrolidone.

Examples of the natural polymer include polysaccharides such as starch, pullulan, dextran, dextrin, guar gum, xanthan gum, amylose, amylopectin, alginic acid, arabic gum, carrageenan, chondroitin sulfate, hyaluronic acid, curdlan, chitin, chitosan, cellulose, carboxymethyl cellulose, and salts (sodium salt, ammonium salt, etc.) or derivatives thereof.

In the present disclosure, the “continuous centrifugal separation” refers to continuously supplying the solution containing the fibrous carbon nanostructures and the solvent to a separator to perform centrifugal separation. Publicly known continuous centrifugal separation may be used for the continuous centrifugal separation in the present disclosure. For example, continuous centrifugal separators described in JP 2017-012974 A, JP 2013-154306 A, and the like may be used. By the nature of centrifugal separation, a supernatant phase and a precipitate phase are obtained as a result of continuous centrifugal separation. The supernatant phase contains fibrous carbon nanostructures having high dispersibility, and the precipitate phase contains fibrous carbon nanostructures having high aggregability. Thus, the supernatant phase obtained in the continuous centrifugal separation step contains a fibrous carbon nanostructure dispersion liquid having high dispersibility.

A commercially-available continuous centrifugal separator may be used. An example of the commercially-available continuous centrifugal separator is product name: himac® CC4ONX (himac is a registered trademark in Japan, other countries, or both) produced by Hitachi Koki Corporation.

The centrifugal acceleration in the continuous centrifugal separation step may be adjusted as appropriate. For example, the centrifugal acceleration is preferably 2000 G or more and more preferably 5000 G or more, and is preferably 40000 G or less and more preferably 30000 G or less.

The centrifugal separation time in the continuous centrifugal separation step may be adjusted as appropriate. For example, the centrifugal separation time is preferably 20 min or more and more preferably 30 min or more, and is preferably 120 min or less and more preferably 90 min or less.

The production method for a fibrous carbon nanostructure dispersion liquid according to the present disclosure may optionally comprise, for example, a pretreatment step and/or a posttreatment step for the fibrous carbon nanostructures before or after the continuous centrifugal separation step or simultaneously with the continuous centrifugal separation step.

The production method for a fibrous carbon nanostructure dispersion liquid according to the present disclosure preferably comprises a step of concentrating the solution using a hollow fiber membrane filter before the continuous centrifugal separation step. The hollow fiber membrane filter is not limited as long as it can concentrate the fibrous carbon nanostructures in the solution (i.e. desired fibrous carbon nanostructures do not pass through the hollow fiber membrane filter). An example is hollow fiber membrane filter module, product name: FS10 produced by Daicen Membrane-Systems Ltd.

The production method for a fibrous carbon nanostructure dispersion liquid according to the present disclosure preferably comprises a step of concentrating the solution using a ceramic rotary filter before the continuous centrifugal separation step. The ceramic rotary filter is not limited as long as it can concentrate the fibrous carbon nanostructures in the solution (i.e. fibrous carbon nanostructures do not pass through the ceramic rotary filter). An example is ceramic rotary filter system, product name: R-fine produced by Hiroshima Metal & Machinery Co., Ltd. The pore size may be adjusted as appropriate. For example, the pore size is 7 nm.

The production method for a fibrous carbon nanostructure dispersion liquid according to the present disclosure may comprise a step of purifying the fibrous carbon nanostructures by removing impurities, e.g. metals such as alkali metal ions, halogens such as halogen ions, and particulate impurities such as oligomers and polymers.

Examples of methods of removing metal impurities include a method of dispersing fibrous carbon nanostructures in an acid solution of nitric acid, hydrochloric acid, or the like and dissolving and removing metal impurities, and a method of removing metal impurities magnetically. Of these, a method of dispersing fibrous carbon nanostructures in an acid solution and dissolving and removing metal impurities is preferable.

Examples of methods of removing particulate impurities include high-speed centrifugal treatment using an ultrahigh-speed centrifuge or the like; filtration treatment by gravity filtration, vacuum filtration, or the like; non-fullerene carbon material selective oxidation; and combinations thereof.

Dispersion Treatment

The solution may be subjected to dispersion treatment. The dispersion method may be, but is not limited to, a publicly known dispersion method used for dispersion of a fibrous carbon nanostructure-containing solution. Dispersion treatment that brings about a cavitation effect or dispersion treatment that brings about a crushing effect described in JP 2016-190772 A as an example is preferable as the dispersion treatment. The use of such dispersion treatment enables favorable dispersion of fibrous carbon nanostructures, and further enhances the dispersibility of the resultant fibrous carbon nanostructure dispersion liquid.

Specific examples of the dispersion treatment that brings about a cavitation effect include dispersion treatment using ultrasound, dispersion treatment using a jet mill, and dispersion treatment using high-shear stirring. One of these dispersion treatments may be carried out or two or more of these dispersion treatments may be carried out in combination. Publicly known conventional devices may be used as these devices.

In the dispersion treatment using ultrasound, in a situation in which an ultrasonic homogenizer is used, the solution is irradiated with ultrasound. The irradiation time may be set as appropriate in consideration of the amount of fibrous carbon nanostructures and so forth. For example, the irradiation time is preferably 3 min or more and more preferably 30 min or more, and preferably 5 hr or less and more preferably 2 hr or less. For example, the output is preferably 20 W to 500 W and more preferably 100 W to 500 W, and the temperature is preferably 15° C. to 50° C.

In the dispersion treatment using a jet mill, the number of treatment repetitions carried out is set as appropriate in consideration of the amount of fibrous carbon nanostructures and so forth. For example, the number of treatment repetitions is preferably at least 2 repetitions, and is preferably no greater than 100 repetitions, and more preferably no greater than 50 repetitions. For example, the pressure is preferably 20 MPa to 250 MPa, and the temperature is preferably 15° C. to 50° C.

In the dispersion treatment using high-shear stirring, the rotational speed is preferably as fast as possible. The operating time (i.e., the time during which the device is rotating) is preferably 3 min or more and 4 hr or less. The circumferential speed is preferably 5 m/sec to 50 m/sec, and the temperature is preferably 15° C. to 50° C.

The dispersion conditions, device, etc. of the dispersion treatment that brings about a crushing effect may be selected as appropriate from the dispersion conditions, devices, etc. described in JP 2016-190772 A, etc.

The fibrous carbon nanostructure dispersion liquid obtained by the production method according to the present disclosure can be used in the production of: chemical sensors such as trace gas detectors; biosensors such as measuring instruments for DNA, protein, and the like; electronic components such as electronic circuits including image sensors, strain sensors, contact sensors, and logic circuits, memories including DRAM, SRAM, NRAM, NAND flash, NOR flash, ReRAM, STT-MRAM, and PRAM, semiconductor devices, interconnects, complementary MOS, and bipolar transistors; and conductive films such as solar cells, liquid crystal panels, organic EL panels, and touch panels. For example, the fibrous carbon nanostructure dispersion liquid is usable as a coating liquid or a constituent material in the production of an electronic product. The fibrous carbon nanostructure dispersion liquid is also usable as an intermediate material when producing a high-strength O-ring, a U-ring, a sealing material, or the like. Of these, the fibrous carbon nanostructure dispersion liquid is suitable as a constituent material of a semiconductor manufacturing device, in terms of enabling obtainment of a product having excellent electrical conductivity and strength.

### EXAMPLES

The following will provide a more specific description of the present disclosure by way of examples. These examples are intended for illustrative purposes only, and are not intended to limit the scope of the present disclosure in any way. The blending amounts are parts by mass, unless otherwise noted.

The following materials were used in the examples:

Single-walled carbon nanotubes: produced by Zeon Nano Technology Co., Ltd., ZEONANO SG101.

Multi-walled carbon nanotubes: produced by CNano Technology Limited, product name: Flotube 9000.

Carboxymethyl cellulose: produced by Wako Pure Chemical Industries, Ltd.

Cellophane film: produced by Futamura Chemical Co., Ltd., product name: P5-1.

The following devices were used in the examples:

Hollow fiber membrane filter module: produced by Daicen Membrane-Systems Ltd., product name: FS10.

Ceramic rotary filter system: produced by Hiroshima Metal & Machinery Co., Ltd., product name: R-fine, filter pore size: 7 nm.

Wet high-pressure jet mill: produced by JOKOH Co., Ltd., product name: Nano Jet Pul® JN1000 (Nano Jet Pul is a registered trademark in Japan, other countries, or both).

Continuous ultracentrifugal separator: produced by Hitachi Koki Corporation, product name: himac® CC40NX. Breaking strength tester: produced by Shimadzu Corporation, product name: EZ-LX.

The “average diameter (Av) of the fibrous carbon nanostructures” and the “diameter standard deviation (σ: sample standard deviation) of the fibrous carbon nanostructures” were each obtained by measuring the diameters (external diameters) of 100 randomly selected fibrous carbon nanostructures using a transmission electron microscope.

The BET specific surface area was measured by automatic operation using a fully automated specific surface area measurement device (produced by Mountech Co., Ltd., product name: Macsorb® HM model-1210 (Macsorb is a registered trademark in Japan, other countries, or both).

The oxygen content of the fibrous carbon nanostructures (CNTs) was measured using an X-ray photoelectron spectrometer (XPS) by partially filtering and collecting the CNTs in the mixed solution and drying them under reduced pressure.

The average diameter of the fibrous carbon nanostructure (CNT) dispersion liquid was measured with the CNT concentration being diluted to 0.005 wt % using a laser scattering type particle size distribution meter (produced by Malvern Panalytical Ltd., product name: Zetasizer Nano ZS), and the cumulant average diameter was calculated.

The absorbance of the fibrous carbon nanostructure (CNT) dispersion liquid was measured under the conditions of an optical path length of 1 mm and a wavelength of 1000 nm using a spectrophotometer (produced by JASCO Corporation, product name: V670).

The single-walled CNTs had a BET specific surface area of 1,050 m²/g, and when measured using a Raman spectrophotometer, exhibited a radial breathing mode (RBM) spectrum in a low wavenumber region from 100 cm⁻¹ to 300 cm⁻¹, which is characteristic of single-walled CNTs. The average diameter (Av) was 3.3 nm, the diameter distribution (3σ) was 1.9, and (3σ/Av) was 0.58.

### Preparation Example 1

100 kg of deionized water, 500 g of carboxymethyl cellulose, and 50 g of the single-walled CNTs were mixed, and subjected to 30 pass treatment at 80 MPa using a wet high-pressure jet mill. As a result, a uniform black solution with no visually identifiable particles was obtained. As a result of measuring the black solution using a laser scattering type particle size distribution meter, the cumulant average diameter was 420 nm. The absorbance of the black solution was 2.64.

### Preparation Example 2

100 kg of deionized water, 500 g of carboxymethyl cellulose, and 250 g of the multi-walled carbon nanotubes were mixed, and subjected to 20 pass treatment at 80 MPa using a wet high-pressure jet mill. As a result, a uniform black solution with no visually identifiable particles was obtained. As a result of measuring the black solution using a laser scattering type particle size distribution meter, the cumulant average diameter was 350 nm. The absorbance of the black solution was 2.38.

### Preparation Example 3

70 g of the single-walled CNTs were mixed with 50 kg of a 50% concentrated sulfuric acid, and the mixed solution was heated under reflux for 5 hr. After cooling the mixed solution, the mixed solution was neutralized with sodium hydroxide to be neutral. As a result of analyzing the CNTs in the mixed solution using an XPS, oxygen was 1.8 at %. After making the mixed solution neutral, the absorption spectrum was measured at an optical path length of 0.1 mm. As a result, the absorbance at a wavelength of 1000 nm was 0.65. This is equivalent to an absorbance of 6.5 when converted to a measurement at an optical path length of 1 mm according to the Lambert-Beer law. The cumulant average diameter was 220 nm.

### Example 1

A tank, a pump, and a hollow fiber membrane filter module were connected by a piping to form a system. This system was charged with 180 kg of the black solution in Preparation Example 1, and operation of discarding the filtrate and collecting the concentrate was performed. When the mass of the concentrate reached 90 kg, the concentration was stopped and the concentrate was collected. The concentrate was treated for 2 hr with a centrifugal force of 30000 G using a continuous ultracentrifugal separator. The CNTs removed by the continuous centrifugal separation were discarded. A dispersion liquid of 80 kg was collected. 1050 g of carboxymethyl cellulose was additionally dissolved in 70 kg of the collected dispersion liquid, to obtain a dispersion liquid in Example 1.

### Comparative Example 1

A dispersion liquid (concentrate) was obtained in the same way as in Example 1, except that no continuous centrifugal separation was performed in Example 1. 1050 g of carboxymethyl cellulose was additionally dissolved in 70 kg of the concentrate in the same way as in Example 1, to obtain a comparative dispersion liquid in Comparative Example 1.

### Example 2

180 kg of the CNT dispersion liquid in Preparation Example 1 was concentrated using a ceramic rotary filter system. The concentration conditions were a filtration pressure of 0.2 MPa and a filter rotational frequency of 1000 rpm. When the mass of the concentrate reached 90 kg, the concentration was stopped and the concentrate was collected. Subsequently, continuous centrifugal separation and carboxymethyl cellulose addition were performed in the same way as in Example 1, to obtain a dispersion liquid in Example 2.

### Comparative Example 2

A dispersion liquid (concentrate) was obtained in the same way as in Example 2, except that no continuous centrifugal separation was performed in Example 2. 1050 g of carboxymethyl cellulose was additionally dissolved in 70 kg of the concentrate in the same way as in Example 2, to obtain a comparative dispersion liquid in Comparative Example 2.

### Example 3

A dispersion liquid in Example 3 was obtained in the same way as in Example 1, except that the black solution in Preparation Example 2 was used instead of the black solution in Preparation Example 1 in Example 1.

### Comparative Example 3

A comparative dispersion liquid in Comparative Example 3 was obtained in the same way as in Comparative Example 1, except that the black solution in Preparation Example 2 was used instead of the black solution in Preparation Example 1 in Comparative Example 1.

### Example 4

A dispersion liquid in Example 4 was obtained in the same way as in Example 1, except that the black solution in Preparation Example 3 was used instead of the black solution in Preparation Example 1 in Example 1.

### Comparative Example 4

A comparative dispersion liquid in Comparative Example 4 was obtained in the same way as in Comparative Example 1, except that the black solution in Preparation Example 3 was used instead of the black solution in Preparation Example 1 in Comparative Example 1.

Production of Film

A film was produced by applying the dispersion liquid or comparative dispersion liquid obtained in each of Examples and Comparative Examples onto a cellophane film by a spray drying method.

Measurement of Surface Resistance

The surface resistance of the produced film was measured in accordance with JIS K 7194. The results are shown in Table 1.

Evaluation of Dispersibility of CNTs in Film

The produced film was observed using an optical microscope with a magnification of ×500. The number of black spots with a diameter of 3 μm or more in the field of vision was counted through image analysis. The results are shown in Table 1.

Measurement of Breaking Strength

The produced film was stretched at 100 mm/min in accordance with JIS K 7161, and the breaking strength was measured. The results are shown in Table 1.

| | Surface | Number of black | Breaking |
|---|---|---|---|
| | resistance | spots with diameter | strength |
| | (Ω/sq.) | of 3 μm or more | (MPa) |
| Example 1 | 3300 | 0 | 110 |
| Comparative Example 1 | 2900 | 13 | 100 |
| Example 2 | 3100 | 0 | 105 |
| Comparative Example 2 | 2950 | 17 | 95 |
| Example 3 | 7400 | 0 | 105 |
| Comparative Example 3 | 7550 | 18 | 95 |
| Example 4 | 2200 | 0 | 105 |
| Comparative Example 4 | 2350 | 21 | 95 |

As can be understood from Table 1, in each Example, a CNT dispersion liquid having high dispersibility was produced efficiently. In comparison of Examples 1, 3, and 4, the films of Examples 1 and 4 using the single-walled CNTs (the black solutions in Preparation Examples 1 and 3) had low surface resistance and excellent electrical conductivity.

### INDUSTRIAL APPLICABILITY

It is therefore possible to provide a method of efficiently producing a fibrous carbon nanostructure dispersion liquid having high dispersibility, and a fibrous carbon nanostructure dispersion liquid having high dispersibility.

1. A production method for a fibrous carbon nanostructure dispersion liquid, comprising
a step of performing continuous centrifugal separation on a solution containing fibrous carbon nanostructures and a solvent.

2. The production method for a fibrous carbon nanostructure dispersion liquid according to claim 1, comprising
a step of concentrating the solution using a hollow fiber membrane filter, before the step of performing continuous centrifugal separation.

3. The production method for a fibrous carbon nanostructure dispersion liquid according to claim 1, comprising
a step of concentrating the solution using a ceramic rotary filter, before the step of performing continuous centrifugal separation.

4. The production method for a fibrous carbon nanostructure dispersion liquid according to claim 1, wherein the solution contains at least fibrous carbon nanostructures that satisfy 0.20<3σ/Av<0.60, where Av is an average diameter of the fibrous carbon nanostructures, and 3σ is a diameter distribution of the fibrous carbon nanostructures.

5. The production method for a fibrous carbon nanostructure dispersion liquid according to claim 1, wherein a BET specific surface area of the fibrous carbon nanostructures contained in the solution is 600 m²/g or more.

6. The production method for a fibrous carbon nanostructure dispersion liquid according to claim 1, wherein an oxygen content of the fibrous carbon nanostructures contained in the solution is 1 at % or more.

7. The production method for a fibrous carbon nanostructure dispersion liquid according to claim 1, wherein an average diameter of the fibrous carbon nanostructures contained in the solution is 10 nm to 1000 nm.

8. The production method for a fibrous carbon nanostructure dispersion liquid according to claim 1, wherein an absorbance of the solution at a wavelength of 1000 nm is 1.5 to 8.0.

9. A fibrous carbon nanostructure dispersion liquid obtainable by the production method according to claim 1.
